(19) United States
(12) Patent Application Publication
(10) Pub. No.: US 2004/0258129 A1
(43) Pub. Date: Dec. 23, 2004

(54) Dishwasher safe thermometer

(76) Inventor: Richard Rund, Great Falls, VA (US)

Correspondence Address: CAHN & SAMUELS LLP, 2000 P STREET NW, SUITE 200, WASHINGTON, DC, 20036, US

(21) Appl. No.: 10/815,990

(22) Filed: Apr. 2, 2004

Related U.S. Application Data
(60) Provisional application No. 60/459,256, filed on Apr. 2, 2003.

(51) Int. Cl. G01K 7/00

(52) U.S. Cl. 374/170

(57) ABSTRACT

In accordance with an aspect of the inveniton digital thermometer comprises a housing having first and second portions, where the first portion defining a cavity. A waterproof seal is disposed between the first and second portions of the housing. Ttemperature conversion logic is disposed within the cavity of said housing and said temperature conversion logic is encapsulated by a material having low thermal conductivity. To protect against high heat, an insulating member is disposed in the cavity of said housing and a probe connected to said housing.

This application claims the benefit of Provisional Patent Application No. 60/459,256 filed Apr. 2, 2003.

### I. FIELD OF THE INVENTION

This invention relates generally to digital thermometers. More particularly, the invention relates to digital thermometers that are capable of operating in a commercial dishwasher.

### II. BACKGROUND OF THE INVENTION

Digital thermometers are widely employed in many applications where it is desirable to measure temperature. In most applications, it is important to thoroughly clean the thermometers after each use. Many conventional thermometers must be cleaned by hand because they cannot withstand the high temperatures and exposure to water that occur when they are mechanically washed, for example in a dishwasher.

In the wash cycle of commercial dishwashers, the temperature is required to reach 180° F. for at least 2 minutes. Because conventional thermometers do not reliably operate under those conditions, it has been difficult to test the peak temperatures of commercial dishwashers.

Accordingly, there is a need for a thermometer that can survive the wash cycle of commercial dishwashers and can test the peak temperature of commercial dishwashers.

### III. SUMMARY OF THE INVENTION

It is an object of this invention to provide a watertight digital thermometer.

It is a further object of the invention to provide a thermometer that is operational in ambient temperatures of 180° F. or more.

In accordance with an aspect of the invention digital thermometer comprises a housing having first and second portions, where the first portion defining a cavity. A waterproof seal is disposed between the first and second portions of the housing. Temperature conversion logic is disposed within the cavity of said housing and said temperature conversion logic is encapsulated by a material having low thermal conductivity. To protect against high heat, an insulating member is disposed in the cavity of said housing and a probe connected to said housing.

Given the following enabling description of the drawings, the apparatus should become evident to a person of ordinary skill in the art.

### IV. BRIEF DESCRIPTION OF THE DRAWINGS

FIG. 1 is a cross sectional view of a thermometer in accordance with the invention.

### V. DETAILED DESCRIPTION OF THE DRAWINGS

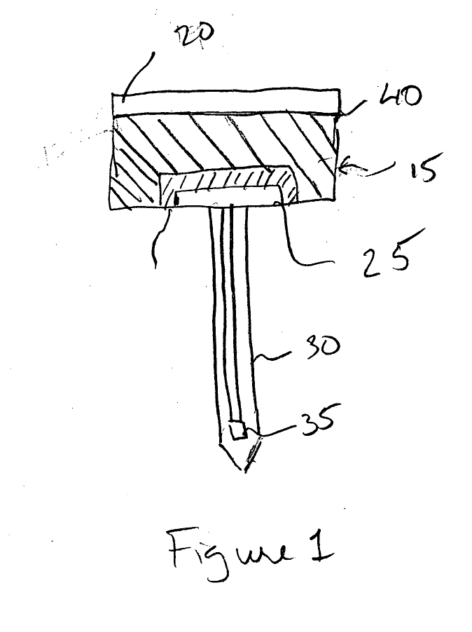

Referring to FIG. 1, an exemplary embodiment of the dishwasher safe digital thermometer includes a housing having at least two parts 15 and 20. One part of the housing 15 defines a cavity in which conventional temperature conversion logic 25 is disposed. A probe 30 is connected to the housing and the probe includes a temperature-sensing element 35.

In keeping with the invention, to protect against water damage, a seal a watertight seal 40 is provided between the first and second parts of the housing.

Further in keeping with the invention temperature conversion logic 25 is encapsulated by a material having low thermal conductivity, e.g., epoxy. ME350A and ME350B available from Lord Corporation of Cary, N.C. are particularly preferred. To help further insulate the temperature control logic and to minimize harmful moisture build-up in the housing, insulating member 45 is disposed in the cavity of the housing. Insulating member 45 is preferably comprised of foam, more preferably polystyrene. Insulating member 45 may be prefabricated using a mold or may be sprayed or blown into the cavity.

In accordance with the invention, seal 40 may be a temperature resistant glue such as LOCTITE® high temperature glue. Alternatively, seal 40 may comprise an ultrasonic weld created using an ultrasonic welding machine such as Model NK-1518 made by NEKON ULTRASONIC. In other embodiments, seal 40 may comprise a gasket disposed between first and second portions 15 and 20 the housing with screws (not shown) interconnecting the first and second portions. As used herein, waterproof seal refers to a seal that meats the international standard for water proofing IEC 529 (IP67).

To withstand the temperatures of commercial dishwashers, the housing is preferably formed from a polymer type thermoplastic such as Polycarbonate or Acrylonitrile Butadiene Styrene.

We claim:

1. A digital thermometer comprising:
a housing having first and second portions, the first portion defining a cavity;
a waterproof seal disposed between the first and second portions of the housing;
temperature conversion logic disposed within the cavity of said housing, said temperature conversion logic being encapsulated by a material having low thermal conductivity;
an insulating member disposed in the cavity of said housing;
a probe connected to said housing; and
a temperature sensing element disposed in said probe.

2. The digital thermometer of claim 1 wherein the waterproof seal includes an ultrasonic weld.

3. The digital thermometer of claim 1 wherein the water proof seal includes a temperature resistant glue.

4. The digital thermometer of claim 1 wherein the waterproof seal includes a gasket and a screw interconnecting the first and second portions of the housing.

5. The digital thermometer of claim 1 wherein the temperature conversion logic is encapsulated by epoxy.

6. The digital thermometer of claim 1 wherein the insulating member comprises foam.

7. The digital thermometer of claim 1 wherein the insulating member comprises polystyrene.

8. A method of making a digital thermometer comprising:
encapsulating a microprocessor in a material having low thermal conductivity;
inserting the microprocessor in a cavity of a first portion of a thermometer housing;
applying a sufficient amount of insulation to the cavity to fill the cavity;
sealing a second portion of the thermometer housing to the first portion of the thermometer housing; and
connecting a probe to the thermometer housing.
